(19) United States
(12) Patent Application Publication
(10) Pub. No.: US 2026/0004476 A1
(43) Pub. Date: Jan. 1, 2026

(54) METHOD AND APPARATUS FOR TRAINING IMAGE GENERATION MODEL, IMAGE GENERATION METHOD AND APPARATUS, DEVICE, AND STORAGE MEDIUM

(71) Applicant: Tencent Technology (Shenzhen) Company Limited, Shenzhen (CN)

(72) Inventor: Chunquan Chen, Shenzhen (CN)

(73) Assignee: Tencent Technology (Shenzhen) Company Limited, Shenzhen (CN)

(21) Appl. No.: 19/318,497

(22) Filed: Sep. 4, 2025

Related U.S. Application Data
(63) Continuation of application No. PCT/CN2024/098402, filed on Jun. 11, 2024.

(30) Foreign Application Priority Data
Aug. 11, 2023 (CN) 202311007976.7

(51) Int. Cl. G06T 11/00; G06V 10/77; G06V 10/774; G06V 10/82

(52) U.S. Cl. CPC G06T 11/00; G06V 10/7715; G06V 10/774; G06V 10/82

(57) ABSTRACT

A method, apparatus, and computer-readable storage medium for training image generation models using varying text description complexity. The method obtains training samples containing first and second description texts corresponding to original images, where the second text contains more keywords than the first. Shallow and deep representations are extracted from the first description text using a text encoder and neural network, forming a comprehensive text representation. A diffusion model generates predicted images from this representation. The second description text is processed to extract a reference text representation. Model parameters are adjusted based on both comprehensive and reference text representations to obtain a trained image generation model capable of enhanced text-to-image generation performance.

### CROSS-REFERENCE TO RELATED APPLICATIONS

This application is a continuation application of International Application No. PCT/CN2024/098402 filed on Jun. 11, 2024 which claims priority to Chinese Patent Application No. 202311007976.7, filed with the China National Intellectual Property Administration on Aug. 11, 2023, the disclosures of each being incorporated by reference herein in their entireties.

### FIELD

The disclosure relates to the field of artificial intelligence (AI) technologies, a method and an apparatus for training an image generation model, a device, and a storage medium.

### BACKGROUND

With continuous development of a text-to-image technology, in a text-to-image model such as a diffusion model, a description text inputted by a user is converted into a predicted image corresponding to the description text.

In the related technology, triple samples (an original image, a predicted image, and a description text) may be used to train the model for an image generation capability, and a trained model can generate the predicted image according to the inputted description text. To improve a training effect of the model, during construction of the description text in the triple samples, a complex and detailed description text for the original image may be obtained, and a complex description text may be needed.

### SUMMARY

Provided are a method and apparatus for training an image generation model, a device, a storage medium, and a program product, which can implement enhanced image generation through multi-level text representation learning using varying description complexity.

According to some embodiments, a method for training an image generation model, performed by a computer device, includes: obtaining at least one training sample, each training sample comprising a first description text and a second description text that corresponds to an original image, wherein the second description text comprises a greater number of keywords describing the original image than the first description text; extracting a shallow representation that corresponds to the first description text with a text encoder and a deep representation that corresponds to the first description text with a neural network; determining, based on the shallow representation and the deep representation, a comprehensive text representation corresponding to the first description text; generating, based on a diffusion model of the original image, a predicted image corresponding to the comprehensive text representation; inputting the second description text to the text encoder, to extract a reference text representation corresponding to the second description text; and adjusting at least one parameter of the image generation model based on the comprehensive text representation and the reference text representation corresponding to the second description text, to obtain a trained image generation model.

According to some embodiments, an apparatus for training an image generation model, includes: at least one memory configured to store program code; and at least one processor configured to read the program code and operate as instructed by the program code, the program code including: obtaining code configured to cause at least one of the at least one processor to obtain at least one training sample, each training sample comprising a first description text and a second description text that corresponds to an original image, wherein the second description text comprises a greater number of keywords describing the original image than the first description text; extracting code configured to cause at least one of the at least one processor to extract a shallow representation that corresponds to the first description text with a text encoder and a deep representation that corresponds to the first description text with a neural network; determining code configured to cause at least one of the at least one processor to determine, based on the shallow representation and the deep representation, a comprehensive text representation corresponding to the first description text; generating code configured to cause at least one of the at least one processor to generate, based on a diffusion model of the original image, a predicted image corresponding to the comprehensive text representation; inputting code configured to cause at least one of the at least one processor to input the second description text to the text encoder, to extract a reference text representation corresponding to the second description text; and adjusting code configured to cause at least one of the at least one processor to adjust at least one parameter of the image generation model based on the comprehensive text representation and the reference text representation corresponding to the second description text, to obtain a trained image generation model.

According to some embodiments, a non-transitory computer-readable storage medium, storing computer code which, when executed by at least one processor, causes the at least one processor to at least: obtain at least one training sample, each training sample comprising a first description text and a second description text that corresponds to an original image, wherein the second description text comprises a greater number of keywords describing the original image than the first description text; extract a shallow representation that corresponds to the first description text with a text encoder and a deep representation that corresponds to the first description text with a neural network; determine, based on the shallow representation and the deep representation, a comprehensive text representation corresponding to the first description text; generate, based on a diffusion model of the original image, a predicted image corresponding to the comprehensive text representation; input the second description text to the text encoder, to extract a reference text representation corresponding to the second description text; and adjust at least one parameter of the image generation model based on the comprehensive text representation and the reference text representation corresponding to the second description text, to obtain a trained image generation model.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment of a solution according to some embodiments.

FIG. 2 is a schematic diagram of a method for training and using an image generation model according to some embodiments.

FIG. 3 is a flowchart of a method for training an image generation model according to some embodiments.

FIG. 4 is a flowchart of a method for training an image generation model according to some embodiments.

FIG. 5 is a flowchart of a method for training an image generation model according to still some embodiments.

FIG. 6 is a schematic diagram of a method for training an image generation model according to some embodiments.

FIG. 7 is a flowchart of a method for training an image generation model according to yet some embodiments.

FIG. 8 is a schematic diagram of a method for determining a simple description text according to some embodiments.

FIG. 9 is a schematic diagram of a method for training an image generation model according to some embodiments.

FIG. 10 is a flowchart of an image generation model-based image generation method according to some embodiments.

FIG. 11 is a schematic diagram of an image generation model according to some embodiments.

FIG. 12 is a block diagram of an apparatus for training an image generation model according to some embodiments.

FIG. 13 is a block diagram of an image generation model-based image generation apparatus according to some embodiments.

FIG. 14 is a structural block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Solutions provided in embodiments of the disclosure relate to technologies such as artificial intelligence computer vision technologies and deep learning. In some embodiments, an image generation model is first adjusted by using a simple description text and a complex description text that correspond to an original image used as a training sample, and then an adjusted image generation model is used to generate a predicted image according to the simple description text. Details are described through the following embodiments.

Before introducing the technical solutions of the disclosure, some terms involved in the disclosure are first explained and described. As a solution, the following related explanations may be arbitrarily combined with the technical solutions of some embodiments, and all fall within the protection scope of some embodiments. Some embodiments include at least part of the following content.

Pre-training model (PTM): A pre-training model is also referred to as a base model and a large model, and refer to a deep neural network (DNN) having a large-scale parameter quantity. The DNN is trained on massive unmarked data. A function approximation capability of the DNN having the large-scale parameter quantity is used to enable the PTM to extract a common feature from data. The PTM is applicable to downstream tasks through technologies such as fine tuning and parameter efficient fine tuning (including methods such as prompt tuning, prefix tuning, adapter, and Low-Rank Adaptation (LoRA)). Therefore, the pre-training model may achieve an ideal effect in a few-shot scenario or a zero-shot scenario. The PTM may be classified into a language model, a visual model (swin-transformer, vision transformer (ViT), and vision mixture-of-experts (V-MOE)), a voice model, a multi-modal model, and the like according to processed data modalities. The multi-modal model refers to a model in which two or more types of data modality feature representations are established. The pre-training model is an important tool for outputting content generated by artificial intelligence, and may also be used as a general interface for connecting a plurality of task models. In some embodiments, a pre-trained model may be considered as a pre-training model.

Text-to-image model: A description text is inputted based on a generation model in a diffusion process. A text-to-image model performs a series of operations on a random noise image x, and generates a text-related predicted image Y with cross attention of a target text. Diffusion model: A diffusion model is a generation model, and is configured to generate an image through diffusion processing from noise samples step by step.

Stable diffusion model: A stable diffusion model is a latent space-based diffusion model, belongs to a text-to-image model, and performs iterative denoising and sampling on an initialized noise image step by step to generate an image. The stable diffusion model in some embodiments includes a pre-trained text encoding module and a pre-trained diffusion module. Certainly, the image generation model in some embodiments is based on the stable diffusion model, and a neural network module is additionally added.

Prompt: A prompt is a description text inputted to a stable diffusion model.

Shallow neural network: A shallow neural network is a neural network including a relatively small number of hidden layers, for example, a neural network including only one or two hidden layers. In the neural network, layers other than an input layer and an output layer are hidden layers. For example, for a convolutional neural network, the hidden layers may include: a convolutional layer, an activation layer, a pooling layer, and a fully-connected layer.

Deep neural network: A deep neural network is a neural network including a relatively large number of hidden layers, for example, a neural network including three or more hidden layers.

Shallow representation: A shallow representation is alternatively referred to as a shallow feature, and is a feature extracted by using a shallow neural network. Because passing through fewer hidden layers, the feature extracted by the shallow neural network (for example, a text encoding module in some embodiments) includes more fine-grained information.

Deep representation: A deep representation is alternatively referred to as a deep feature, and is a feature extracted by using a deep neural network. The deep neural network can capture coarser-grained and more abstract information, for example, semantic information.

Reference text representation: A reference text representation is a text representation configured for evaluating accuracy of other text representations. For example, in some embodiments, the reference text representation may be a text representation corresponding to a complex description text, such as a text representation of a complex description text extracted by a text encoding module. Because the text encoding module is pre-trained by using the complex description text as a part of training samples, an extraction result of the text representation of the complex description text by the text encoding module is relatively accurate. Therefore, the text representation of the complex description text extracted by the text encoding module may be used as the reference text representation corresponding to the complex description text. In addition, the reference text representation may alternatively be a text representation corresponding to a simple description text. For example, a text representation of a simple description text extracted by using a pre-trained language model (for example, a large language model) may be used as the reference text representation corresponding to the simple description text. Because the large language model has an excellent semantic understanding capability, the text representation of the simple description text extracted by using the pre-trained large language model may be used as the reference text representation corresponding to the simple description text.

Complex description text: A complex description text is alternatively referred to as a complex prompt, and is a description text inputted to a diffusion model. Compared with a simple description text, the complex description text includes more key words, so that the diffusion model can generate a high-quality image. For example, the complex description text may be a description text including more than a predetermined quantity of key words, or a description text whose length exceeds a predetermined threshold.

Simple description text: A simple description text is alternatively referred to as a simple prompt. Compared with a complex description text, the simple description text includes fewer key words. When a user inputs the simple description text to a diffusion model, because a semantic understanding capability and a knowledge reasoning capability of the diffusion model are limited, a generated image has poor quality. For example, the simple description text may be a description text including keywords that do not exceed a predetermined quantity or a description text whose length does not exceed a predetermined threshold.

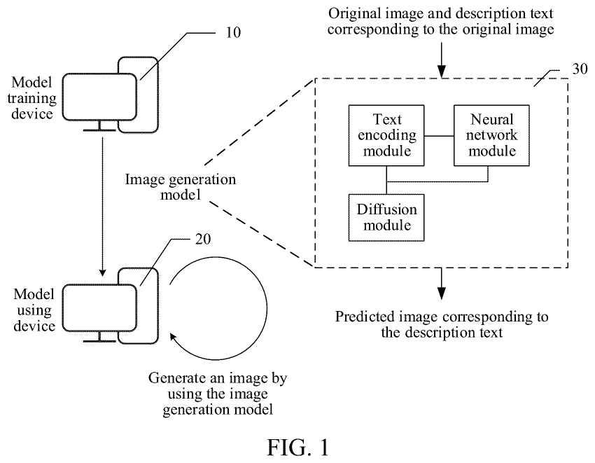

FIG. 1 is a schematic diagram of an implementation environment of a solution according to some embodiments. The implementation environment of the solution may include a model training device 10 and a model using device 20.

The model training device 10 may be an electronic device such as a mobile phone, a desktop computer, a tablet computer, a notebook computer, an in-vehicle terminal, a server, an intelligent robot, an intelligent television, or a multimedia playback device, or some other electronic devices having a strong computing capability. This is not limited in the disclosure. The model training device 10 is configured to train an image generation model 30.

In some embodiments, the image generation model 30 is a machine learning model. In some embodiments, the model training device 10 may train the image generation model 30 in a machine learning manner, so that the image generation model 30 has good performance. In some embodiments, the image generation model 30 includes a neural network module, a pre-trained text encoding module, and a pre-trained diffusion module. A training process of the image generation model 30 is as follows (which is only briefly described herein; for a training process, refer to the following embodiment): obtaining at least one training sample, each training sample including a complex description text and a simple description text that correspond to an original image; extracting, by using a text encoding module and a neural network module, a shallow representation and a deep representation that correspond to the simple description text; determining, according to the shallow representation and the deep representation, a comprehensive text representation corresponding to the simple description text, the comprehensive text representation being configured for generating, by using the diffusion module with reference to the original image, a predicted image corresponding to the comprehensive text representation; inputting the complex description text to the text encoding module, to extract a reference text representation corresponding to the complex description text; and adjusting a parameter of the image generation model 30 according to the comprehensive text representation and the reference text representation corresponding to the complex description text, to obtain a trained image generation model 30. In some embodiments, the text encoding module is configured to extract, with reference to the neural network module, a comprehensive text representation corresponding to a description text. In some other embodiments, the diffusion module is configured to generate the predicted image according to a text representation of the description text and the original image. For a internal processing procedure of the diffusion model, refer to explanations and descriptions of the following embodiments. In some embodiments, the text encoding module and the diffusion module are both machine learning models.

In some embodiments, the model using device 20 may be an electronic device such as a mobile phone, a desktop computer, a tablet computer, a notebook computer, an in-vehicle terminal, a server, an intelligent robot, an intelligent television, or a multimedia playback device, or some other electronic devices having a strong computing capability. This is not limited in the disclosure. For example, the trained image generation model 30 may be configured to generate the predicted image based on the simple description text. In some embodiments, an image generation process of the image generation model 30 is as follows (which is only briefly described herein; for a use process, refer to the following embodiment): obtaining an original image and a simple description text; extracting, by using a text encoding module and a neural network module, a shallow representation and a deep representation that correspond to the simple description text; determining, according to the shallow representation and the deep representation, a comprehensive text representation corresponding to the simple description text, the comprehensive text representation being configured for reflecting the shallow representation and the deep representation; and inputting the comprehensive text representation corresponding to the simple description text to the diffusion module, to generate a predicted image.

The model training device 10 and the model using device 20 may be two independent devices, or may be the same device.

In the method provided in some embodiments, each operation may be performed by a computer device. The computer device refers to an electronic device having data computing, processing, and storage capabilities. When the electronic device is a server, the server may be an independent physical server, or may be a server cluster formed by a plurality of physical servers or a distributed system, or may be a cloud server providing a cloud computing service. The computer device may be the model training device 10 or the model using device 20 in FIG. 1.

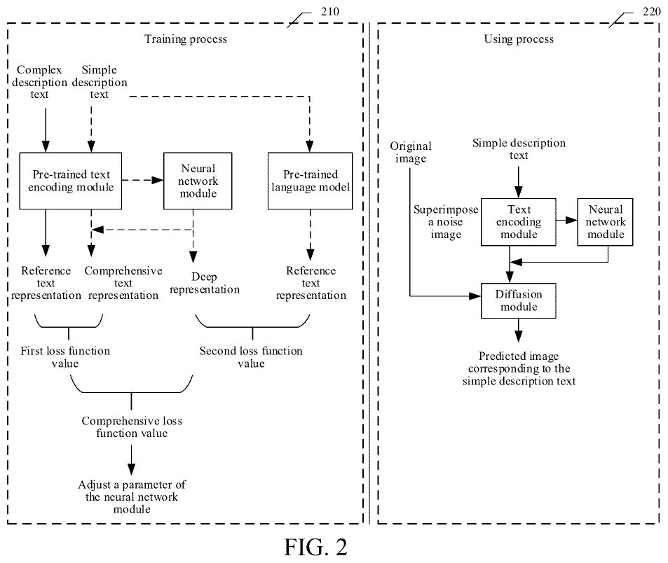

FIG. 2 is a schematic diagram of a method for training and using an image generation model according to some embodiments.

As shown in FIG. 2, the method for training and using an image generation model includes a training process 210 and a using process 220.

For example, a training procedure of the training process 210 is as follows: obtaining at least one training sample, each training sample including a complex description text and a simple description text that correspond to an original image; extracting, by using a text encoding module and a neural network module, a shallow representation and a deep representation that correspond to the simple description text; determining, according to the shallow representation and the deep representation, a comprehensive text representation corresponding to the simple description text; inputting the complex description text to the text encoding module, to extract a reference text representation corresponding to the complex description text; and adjusting a parameter of the image generation model according to the comprehensive text representation and the reference text representation corresponding to the complex description text, to obtain a trained image generation model.

In some embodiments, a first loss function value may be determined according to a difference between the comprehensive text representation and the reference text representation corresponding to the complex description text; and the parameter of the image generation model is adjusted according to the first loss function value, to obtain the trained image generation model.

In some embodiments, the simple description text may be inputted to a pre-trained language model, to extract a reference text representation corresponding to the simple description text; and a second loss function value is determined according to a difference between the deep representation corresponding to the simple description text and the reference text representation corresponding to the simple description text; a comprehensive loss function value is obtained according to the first loss function value and the second loss function value; and a parameter of the neural network module in the image generation model is adjusted according to the comprehensive loss function value, to obtain the trained neural network module.

In some embodiments, the adjusting a parameter of the image generation model includes: adjusting a parameter of the neural network module, parameters of the text encoding module and the diffusion module in the image generation model remaining unchanged.

The trained image generation model includes a pre-trained diffusion model and a trained neural network module.

For example, a procedure of the using process 220 is as follows: obtaining an original image and a simple description text; extracting, by using a text encoding module and a neural network module, a shallow representation and a deep representation that correspond to the simple description text; determining, according to the shallow representation and the deep representation, a comprehensive text representation corresponding to the simple description text; and inputting the comprehensive text representation corresponding to the simple description text to the diffusion module, and generating, by the diffusion module according to the original image and the comprehensive text representation, the predicted image corresponding to the simple description text. The original image herein may be considered as a noise image, or another related or unrelated image.

The following explains and describes an image generation method in the related technology.

In the related technology, the user may manually write the complex prompt (complex description text) including a large number of key words, and use the complex prompt as an input of the stable diffusion model, to generate an image of high quality. When the user inputs a short narrative prompt (simple description text), because the semantic understanding capability and the knowledge reasoning capability of the stable diffusion model are limited, a generated image has poor quality, and it is difficult to satisfy a requirement of the user. In the related technology, the user may write a tedious and complex prompt as the input of the stable diffusion model, to generate a high-quality image. Writing the complex prompt is not friendly to a non-experienced user. It requires professional knowledge and has a high threshold, which will lead to poor user experience. When the user inputs the short narrative prompt, because the semantic understanding capability and the knowledge reasoning capability of the stable diffusion model are limited, the generated image has the poor quality and cannot satisfy the requirement of the user. Generally, the complex prompt can be complied as the input of the stable diffusion model to generate the high-quality image, but the complex prompt is difficult to be complied, and a user threshold is high. However, when the simple prompt is inputted, quality of the image generated by the stable diffusion model is poor.

According to the technical solutions provided in some embodiments, based on the excellent semantic understanding and knowledge reasoning capabilities of the large language model (pre-trained language model), an additional neural network layer (neural network module) is inserted into the stable diffusion model as a semantic adapter, and semantic representations (text representations) of the simple prompt and the complex prompt are aligned through knowledge distillation for the large language model, to improve semantic understanding and knowledge reasoning capabilities of the stable diffusion model for the short prompt. A text encoder of the stable diffusion model can construct a high-quality text semantic representation to generate an image, thereby improving an effect of generating an image by using the simple prompt. In addition, during fine tuning of the stable diffusion model, a pre-trained model parameter is frozen, and only the newly inserted additional neural network layer is trained, thereby reducing a quantity of model parameters that need to be trained, and implementing efficient parameter fine tuning. This not only reduces video memory occupation at a fine tuning stage and lowers a requirement on hardware resources, but also increases a training speed and reduces time consumed by training. Generally, an additional neural network layer configured for semantic adaptation is inserted into the stable diffusion model by using the excellent semantic understanding and knowledge reasoning capabilities of the large language model, thereby aligning semantic representations of the simple prompt and the complex prompt, and improving an effect of generating an image by using the short prompt. Through the technical solutions provided in some embodiments, a semantic difference between the simple prompt and the complex prompt is compensated through knowledge distillation of the large language model, thereby improving an image generation effect of inputting the simple prompt to the stable diffusion model. The technical solutions may be applied to a text-to-image task, for example, generation of an avatar and generation of a cover picture.

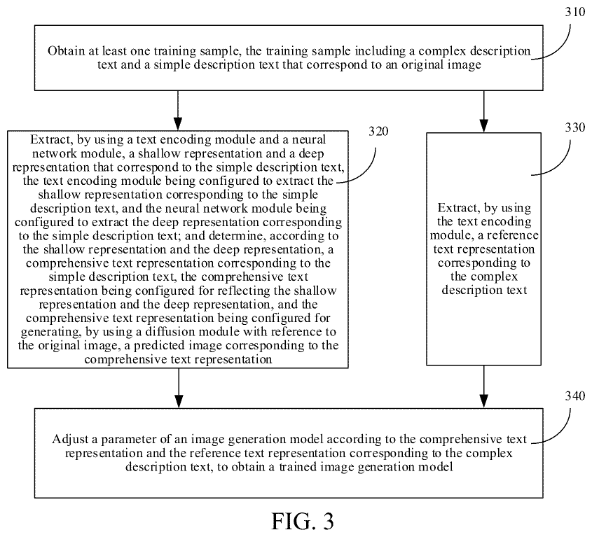

FIG. 3 is a flowchart of a method for training an image generation model according to some embodiments. Each operation of the method may be performed by the model training device described above. In the following method embodiments, for ease of description, a “computer device” is used as an execution body of each operation for description. The method may include at least one of the following operations (310 to 340).

Operation 310: Obtain at least one training sample, each training sample including a complex description text and a simple description text that correspond to an original image.

In a model training process, it is considered that the original image is an image corresponding to the complex description text, for example, content represented in the original image conforms to the complex description text. It is considered that the simple description text is a text expected to be used for generating the original image based on an image generation model. A description text corresponding to the original image is configured for describing content of the original image. In some embodiments, the description text corresponding to the original image may be a real text inputted by the user, or may be a text extracted from the original image by using a model. A manner of obtaining the description text is not limited in some embodiments. Certainly, a word count, a display type, a display style, and the like of the description text are not limited in some embodiments. The description text may represent a whole scenario feature of the original image, or may represent a feature for a main object in the original image. This is not limited in the disclosure. In some embodiments, the description text corresponding to the original image is classified into the simple description text and the complex description text.

Obtaining sources of the complex description text and the simple description text are not limited in some embodiments. For example, the original image and the complex description text corresponding to the original image are crawled from an image and text database website. For example, the simple description text corresponding to the original image is obtained based on the original image. For example, the simple description text corresponding to the original image is obtained in a manual description manner. For another example, the simple description text corresponding to the original image is obtained according to the original image by using a simple image-to-text model. The image-to-text model is a machine learning model, an input of the image-to-text model is the original image, and an output of the image-to-text model is the simple description text corresponding to the original image.

In some embodiments, text content respectively corresponding to the simple description text and the complex description text is different. In some embodiments, a character length of the simple description text is less than a first threshold, and a character length of the complex description text is greater than a second threshold. The first threshold is less than or equal to the second threshold, and a value of the first threshold or the second threshold is not limited in the disclosure. In some embodiments, a matching score between the complex description text and the original image is greater than a matching score between the simple description text and the original image. In some embodiments, resolutions respectively corresponding to a first image generated based on the complex description text by using a text-to-image model and a second image generated based on the simple description text by using the text-to-image model are different, and the resolution of the first image is greater than the resolution of the second image. In some embodiments, character content included in the complex description text completely includes character content included in the simple description text. In some embodiments, the character content included in the complex description text does not completely include the character content included in the simple description text. In some embodiments, for the same original image, the complex description text is “A small rabbit crosses a grassland in a night sky with stars. The milky way shines brightly overhead, casting a soft glow. The fur of the rabbit gleams in the light of countless stars. The rabbit skips across the field, with small body moving gracefully through the tall grass. In the distance, the falling stars scribe across the sky, and leave a light trace behind. The rabbit pauses for a while, is admirably looking up at sky strange watches, and then continues to play a game in a quiet wilderness”, and the simple description text is “A white rabbit sits on a lawn under the sky”.

Operation 320: Extract, by using a text encoding module and a neural network module, a shallow representation and a deep representation that correspond to the simple description text, the text encoding module being configured to extract the shallow representation corresponding to the simple description text, and the neural network module being configured to extract the deep representation corresponding to the simple description text; and determine, according to the shallow representation and the deep representation, a comprehensive text representation corresponding to the simple description text, the comprehensive text representation being configured for reflecting the shallow representation and the deep representation, and being configured for generating, by using a diffusion module with reference to the original image, a predicted image corresponding to the comprehensive text representation.

The image generation model in some embodiments includes a neural network module, a pre-trained text encoding module, and a pre-trained diffusion module. The text encoding module and the diffusion module are both pre-trained. A pre-training process of the text encoding module and the diffusion module is not limited in some embodiments. For example, a noise image is generated based on a random noise seed, the noise image is encoded, and noise addition is performed a plurality of times on an encoded feature through a forward process of the diffusion module, to obtain a latent space representation. The text representation is obtained according to the description text by using the text encoding module. Denoising is performed a plurality of times on the latent space representation based on the text representation through a reverse process of the diffusion model, to obtain a denoised feature, and a predicted image is obtained through decoding. Parameter adjustment is performed on the text encoding module and the diffusion module according to a difference between the original image used as a training sample and the generated predicted image, to obtain the pre-trained text encoding module and the pre-trained diffusion module. Specific architectures of the text encoding module and the diffusion module are not limited in some embodiments. Both of the text encoding module and the diffusion module are machine learning modules. An input of the text encoding module is a text, and an output of the text encoding module is a text representation; and an input of the diffusion module is an original image and a text representation, and an output of the diffusion module is a predicted image.

The neural network module and the text encoding module in some embodiments are both modules configured to extract a text representation. A connection manner between the neural network module and the text encoding module is not limited in some embodiments. For example, the text encoding module and the neural network module are connected in series, or the text encoding module and the neural network module are connected in parallel. In some embodiments, the text encoding module is configured to extract the shallow representation of the text, and the neural network module is configured to extract the deep representation of the text.

In some embodiments, the text encoding module and the neural network module are connected in parallel. For example, a quantity of convolutional layers included in the text encoding module is less than a quantity of convolutional layers included in the neural network module, or a quantity of pooling layers included in the text encoding module is less than a quantity of pooling layers included in the neural network module. In some embodiments, because the quantity of convolutional layers included in the text encoding module is less than the quantity of convolutional layers included in the neural network module, or the quantity of pooling layers included in the text encoding module is less than the quantity of pooling layers included in the neural network module, the text encoding module is configured to extract the shallow representation of the text, and the neural network module is configured to extract the deep representation of the text.

In some other embodiments, the text representation module and the neural network module are connected in series, and an output of the text representation module is used as an input of the neural network module. The output of the text representation module may be considered as the shallow representation, and an output obtained by the neural network module based on the shallow representation is considered as the deep representation.

In some embodiments, the comprehensive text representation corresponding to the simple description text is extracted by using the text encoding module and the neural network module. For example, when the text encoding module and the neural network module are connected in parallel, the shallow representation outputted by the text encoding module for an input text and the deep representation outputted by the neural network module for the input text are comprehensively considered, to obtain the comprehensive text representation. For example, when the text encoding module and the neural network module are connected in series, the shallow representation outputted by the text encoding module for the input text and the deep representation outputted by the neural network module for the shallow representation are comprehensively considered, to obtain the comprehensive text representation.

A manner of determining the comprehensive text representation is not limited in some embodiments. For example, after dimension alignment is performed on the shallow representation and the deep representation, the shallow representation and the deep representation are directly added to obtain the comprehensive text representation. For example, after dimension alignment is performed on the shallow representation and the deep representation, weighted summation is performed to obtain the comprehensive text representation. For example, the shallow representation and the deep representation are multiplied to obtain the comprehensive text representation.

Operation 330: Input the complex description text to the text encoding module, to extract a reference text representation corresponding to the complex description text.

In some embodiments, the complex description text is inputted to the text encoding module, and the reference text representation corresponding to the complex description text is extracted. Because the text encoding module is pre-trained by using the complex description text as a part of training samples, an extraction result of the text representation of the complex description text by the text encoding module is accurate. For example, it may be considered that the text representation extracted by the text encoding module for the complex description text is the reference text representation.

Operation 340: Adjust a parameter of an image generation model according to the comprehensive text representation and the reference text representation corresponding to the complex description text, to obtain a trained image generation model.

A manner of adjusting the parameter of the image generation model by using the comprehensive text representation and the reference text representation corresponding to the complex description text is not limited in some embodiments. For example, a loss function value is determined by using the comprehensive text representation and the reference text representation corresponding to the complex description text, and the parameter of the image generation model is adjusted according to the loss function value, to obtain the trained image generation model. In some embodiments, the additional neural network module is added based on the pre-trained text encoding module, so that after training is completed, the comprehensive text representation extracted for the simple description text based on the text encoding module and the neural network can be comparable to the reference text representation extracted for the complex description text by the text encoding module, thereby improving image generation precision.

A manner of adjusting the parameter of the image generation model is not limited in some embodiments. For example, all parameters in the image generation model are adjusted according to the comprehensive text representation and the reference text representation corresponding to the complex description text, to obtain the trained image generation model. For example, some parameters in the image generation model are adjusted according to the comprehensive text representation and the reference text representation corresponding to the complex description text, to obtain the trained image generation model. For example, according to the comprehensive text representation and the reference text representation corresponding to the complex description text, a parameter of the additionally added neural network module in the image generation model is adjusted, without changing a parameter of another pre-trained module, to obtain the trained image generation model. In this manner, parameter adjustment costs can be reduced, and model training efficiency can be improved. For another example, parameters of the neural network module and the text encoding module in the image generation model are adjusted according to the comprehensive text representation and the reference text representation corresponding to the complex description text, without changing a parameter of the diffusion module, to obtain the trained image generation model. In this manner, consistency between the comprehensive text representation corresponding to the simple description text and the reference text representation corresponding to the complex description text may be ensured.

In the technical solutions provided in some embodiments, the neural network module is introduced based on the pre-trained text encoding module, and the parameter of the image generation model is adjusted by using the comprehensive text representation corresponding to the simple description text and the reference text representation corresponding to the complex description text, so that the comprehensive text representation corresponding to the simple description text in the adjusted model can be aligned with the reference text representation corresponding to the complex description text, thereby implementing that when the input of the user is the simple description text, the comprehensive text representation obtained after passing through the text encoding module and the neural network module can have a text representation with the same semantic richness as the reference text representation corresponding to the complex description text, thereby improving the semantic understanding and knowledge reasoning capabilities of the image generation model, and improving image precision of the subsequently generated predicted image.

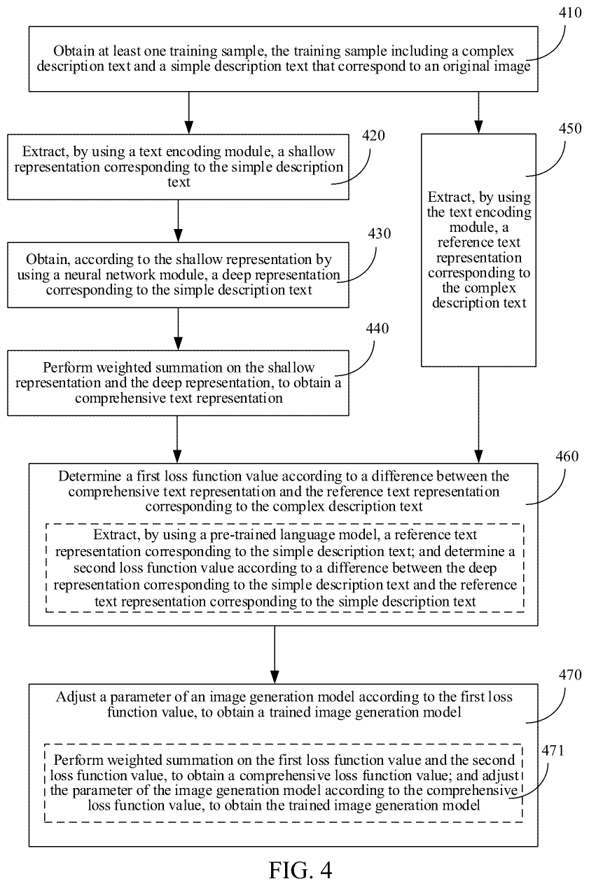

FIG. 4 is a flowchart of a method for training an image generation model according to some embodiments. Each operation of the method may be performed by the model training device described above. In the following method embodiments, for ease of description, a computer device is used as an execution body of each operation for description. The method may include at least one of the following operations (410 to 470).

Operation 410: Obtain at least one training sample, each training sample including a complex description text and a simple description text that correspond to an original image.

In some embodiments, a simple prompt (simple description text) is recorded as pₛ, a complex prompt (complex description text) is recorded as p_{c}, a text encoder (text encoding module) is recorded as a function f_{enc}( ) a pre-trained language model is recorded as f_{LLM}( ) and a newly inserted adapter module (neural network module) is recorded as f_{ad}( ) After the simple prompt is represented by the text encoder in the stable diffusion model, the simple prompt is then sent to the newly inserted adapter module.

Operation 420: Extract, by using a text encoding module, a shallow representation corresponding to the simple description text.

In some embodiments, an input of the text encoding module is the simple description text, and an output of the text encoding module is the shallow representation corresponding to the simple description text. A size of the shallow representation is not limited in some embodiments. The shallow representation may be considered as a feature vector, a vector matrix, or the like outputted by the text encoding module.

In some embodiments, the shallow representation corresponding to the simple description text is represented as f_{enc}(pₛ).

Operation 430: Obtain, according to the shallow representation by using a neural network module, a deep representation corresponding to the simple description text.

In some embodiments, an input of the neural network module is the shallow representation, and an output of the neural network module is the deep representation corresponding to the simple description text. A size of the deep representation is not limited in some embodiments, and the deep representation may be considered as a feature vector, a vector matrix, or the like outputted by the neural network module.

In some embodiments, the deep representation corresponding to the simple description text is represented as f_{ad}(f_{enc}(pₛ)).

Operation 440: Perform weighted summation on the shallow representation and the deep representation, to obtain the comprehensive text representation.

In some embodiments, the simple description text corresponds to the comprehensive text representation v_{LLM}=β·f_{ad}(f_{enc}(pₛ))+(1−β)·f_{enc}(pₛ).

A value of a weight value β is not limited in some embodiments.

Operation 450: Extract, by using the text encoding module, a reference text representation corresponding to the complex description text.

In some embodiments, the input of the text encoding module is the complex description text, and the output of the text encoding module is the reference text representation corresponding to the complex description text. A size of the reference text representation is not limited in some embodiments. The reference text representation may be considered as a feature vector, a vector matrix, or the like outputted by the text encoding module.

In some embodiments, the reference text representation corresponding to the complex description text is represented as f_{enc}(p_{c}).

Operation 460: Determine a first loss function value according to a difference between the comprehensive text representation and the reference text representation corresponding to the complex description text.

In some embodiments, a manner of determining the first loss function value according to the difference between the comprehensive text representation and the reference text representation corresponding to the complex description text is not limited. In some embodiments, the loss function includes, but is not limited to, a cross entropy loss function, a mean square error loss function, a Huber loss function, and the like.

In some embodiments, the loss function is a Kullback-Leibler (KL) divergence function, also referred to as a relative entropy function. For example, the first loss function value Loss_{cp}=KL[v_{LLM}, f_{enc}(p_{c})].

In some embodiments, operation 460 further includes: extracting, by using a pre-trained language model, a reference text representation corresponding to the simple description text; and determining a second loss function value according to a difference between the deep representation corresponding to the simple description text and the reference text representation corresponding to the simple description text.

In some embodiments, an input of the pre-trained language model is the simple description text, and an output of the pre-trained language model is the reference text representation corresponding to the simple description text. A size of the reference text representation is not limited in some embodiments. The reference text representation may be considered as a feature vector, a vector matrix, or the like outputted by the pre-trained language model.

A architecture of the pre-trained language model and a pre-training manner are not limited in some embodiments. For example, the pre-trained language model is a large language model. In some embodiments, the large language model herein may be an open-source LLaMA model or a BLOOM model.

In some embodiments, the simple description text corresponds to the reference text representation f_{LLM}(pₛ).

In some embodiments, the second loss function value is determined according to the difference between the comprehensive text representation and the reference text representation corresponding to the simple description text. In some embodiments, a manner of determining the second loss function value according to the difference between the deep representation corresponding to the simple description text and the reference text representation corresponding to the simple description text is not limited. In some embodiments, the loss function includes, but is not limited to, a cross entropy loss function, a mean square error loss function, a Huber loss function, and the like.

In some embodiments, the loss function is a Kullback-Leibler (KL) divergence function, also referred to as a relative entropy function. For example, the second loss function value LOSS_{LLM}=KL[f_{ad}(f_{enc}(pₛ)), f_{LLM}(pₛ)].

Operation 470: Adjust a parameter of an image generation model according to the first loss function value, to obtain a trained image generation model.

In some embodiments, a manner of performing parameter adjustment on the image generation model according to the first loss function value is not limited. For example, minimizing the first loss function value is used as a target to adjust the parameter of the image generation model, to obtain the trained image generation model. For example, parameter adjustment includes forward gradient update or reverse gradient update. This is not limited in the disclosure either.

In some embodiments, the parameter of the image generation model is adjusted by using the first loss function value, so that the text representation of the complex description text can be aligned with the text representation of the simple description text, thereby improving accuracy of the predicted image generated based on the text representation.

In some embodiments, operation 470 further includes operation 471.

Operation 471: Adjust the parameter of the image generation model according to the first loss function value and the second loss function value, to obtain the trained image generation model.

In some embodiments, a manner of performing parameter adjustment on the generated image according to the first loss function value and the second loss function value is not limited.

In some embodiments, operation 471 further includes: performing weighted summation on the first loss function value and the second loss function value, to obtain a comprehensive loss function value; and adjusting the parameter of the image generation model according to the comprehensive loss function value, to obtain the trained image generation model.

In some embodiments, the comprehensive loss function Loss=ΔLOSS_{LLM}+(1−λ)Loss_{cp}. A value of a weight value λ is not limited in some embodiments.

Certainly, in addition to the weighted summation manner, another manner may also be used for calculating the comprehensive loss function value. For example, the first loss function value and the second loss function value are directly added to obtain the comprehensive loss function value. For example, the first loss function value and the second loss function value are multiplied to obtain the comprehensive loss function value.

In some embodiments, a manner of performing parameter adjustment on the image generation model according to the comprehensive loss function value is not limited. For example, minimizing the comprehensive loss function value is used as a target to adjust the parameter of the image generation model, to obtain the trained image generation model. For example, parameter adjustment includes forward gradient update or reverse gradient update. This is not limited in the disclosure either.

In some other embodiments, when the parameter of the image generation model is adjusted, the parameter of the neural network module is adjusted, and parameters of the text encoding module and the diffusion module in the image generation model remain unchanged.

In some embodiments, an objective of introducing the second loss function value is to enable alignment to the pre-trained language model by using the additional neural network module, so that the deep representation of the simple description text that is obtained by using the neural network module can have rich semantics the same as the reference text feature outputted by the large language model, thereby improving a capability of the neural network module to understand the text, and implementing knowledge distillation for the large language model.

Certainly, in some embodiments, when the image generation model is adjusted, the parameter of the neural network module is adjusted, and the parameters of the text encoding module and the diffusion module in the image generation model remain unchanged. For example, in the fine tuning stage, a pre-trained model parameter of the diffusion model is frozen and stable, and only the newly inserted additional neural network module configured for semantic adaptation is trained, thereby implementing efficient fine tuning of the parameter.

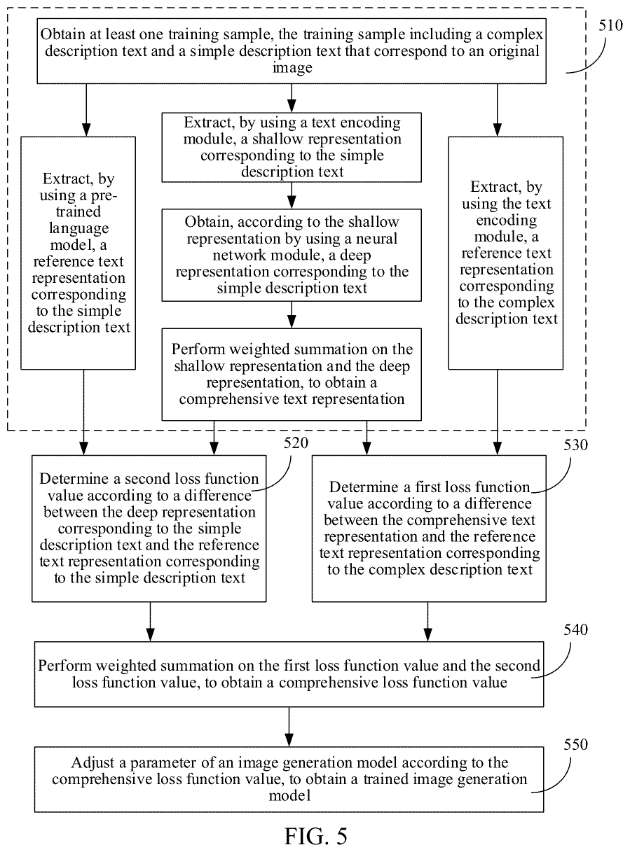

FIG. 5 is a flowchart of a method for training an image generation model according to still some embodiments. Each operation of the method may be performed by the model training device described above. In the following method embodiments, for ease of description, a computer device is used as an execution body of each operation for description. The method may include at least one of the following operations (510 to 550).

Operation 510: Obtain at least one training sample, each training sample including a complex description text and a simple description text that correspond to an original image.

Operation 510 further includes: extracting, by using a pre-trained language model, a reference text representation corresponding to the simple description text; extracting, by using a text encoding module, a shallow representation corresponding to the simple description text; obtaining, according to the shallow representation by using a neural network module, a deep representation corresponding to the simple description text; performing weighted summation on the shallow representation and the deep representation, to obtain a comprehensive text representation; and extracting, by using the text encoding module, a reference text representation corresponding to the complex description text.

Operation 520: Determine a second loss function value according to a difference between the deep representation corresponding to the simple description text and the reference text representation corresponding to the simple description text.

Operation 530: Determine a first loss function value according to a difference between the comprehensive text representation corresponding to the simple description text and the reference text representation corresponding to the complex description text.

Operation 540: Perform weighted summation on the first loss function value and the second loss function value, to obtain a comprehensive loss function value.

Operation 550: Adjust a parameter of an image generation model according to the comprehensive loss function value, to obtain a trained image generation model.

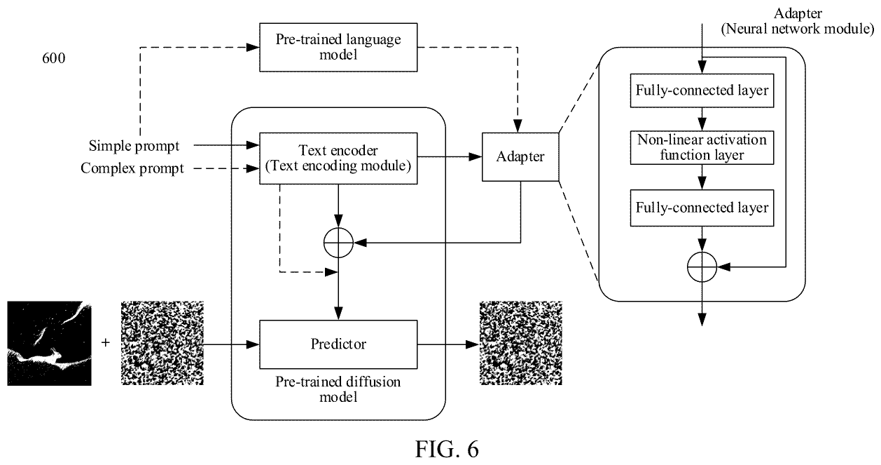

FIG. 6 is a schematic diagram of a method for training an image generation model according to some embodiments. As shown in 600 of FIG. 6, to improve semantic understanding and knowledge reasoning capabilities of a stable diffusion model (the image generation model), an additional neural network module (for example, an adapter) configured for semantic adaptation is inserted after a text encoder (a text encoding module) of the stable diffusion model. The adapter includes at least one fully-connected layer and at least one non-linear activation function layer. In some embodiments, the neural network module includes two fully-connected layers and a non-linear activation function layer. A adjustment process is as follows: After obtaining the shallow representation after passing through the text encoder of the stable diffusion model, the simple prompt is then sent to a newly inserted adapter module to obtain the deep representation. The shallow representation and the deep representation are weighted to obtain the comprehensive text representation corresponding to the simple prompt. After the simple prompt passes through the large language model (the pre-trained language model), the reference text representation corresponding to the simple prompt is obtained. After the complex prompt passes through the text encoder, the reference text representation corresponding to the complex prompt is obtained. The first loss function value is determined according to a KL divergence between the reference text representation corresponding to the complex prompt and the comprehensive text representation corresponding to the simple prompt. The second loss function value is determined according to a KL divergence between the deep representation corresponding to the simple prompt and the reference text representation corresponding to the simple prompt. Weighted summation is performed on the first loss function value and the second loss function value, to obtain the comprehensive loss function value, and the parameter of the adapter module (the neural network module) in the image generation model is adjusted by using the comprehensive loss function value.

In the technical solutions provided in some embodiments, the excellent semantic understanding capability of the large language model is used, and the additional neural network layer configured for semantic adaptation is inserted into the stable diffusion model, to resolve a semantic expression difference between the simple prompt and the complex prompt, thereby improving the semantic understanding and knowledge reasoning capabilities of the stable diffusion model for a short prompt, and improving an image generation effect by using the simple prompt. In addition, when the stable diffusion model is finely tuned, only the newly inserted additional neural network layer is trained, thereby implementing efficient parameter fine tuning. This not only reduces video memory occupation at a fine tuning stage and reduces a requirement on hardware resources, but also increases a training speed and reduces time consumption of training. Generally, the additional neural network layer is inserted into the stable diffusion model as a semantic adapter by using the excellent semantic understanding and knowledge reasoning capabilities of the large language model, thereby aligning semantic representations of the simple prompt and the complex prompt, and improving an effect of generating an image by using the short prompt.

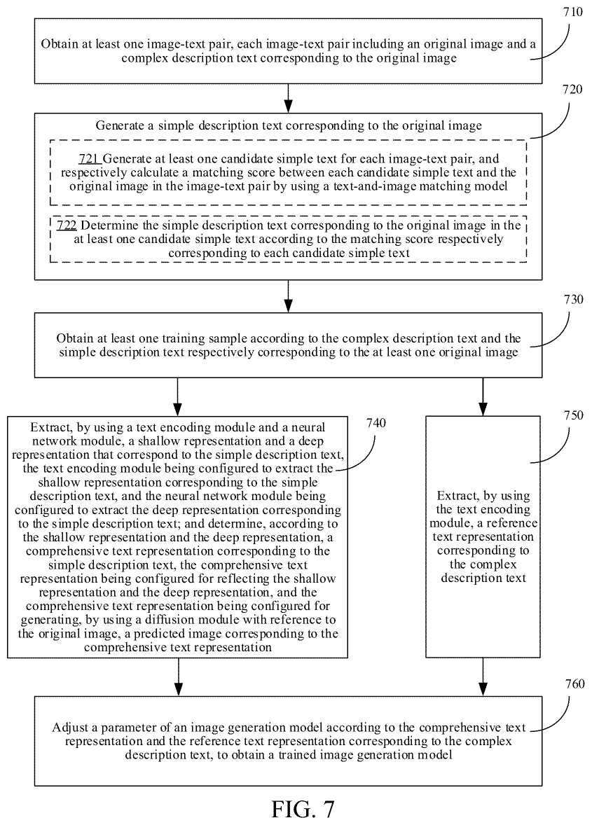

FIG. 7 is a flowchart of a method for training an image generation model according to yet some embodiments. Each operation of the method may be performed by the model training device described above. In the following method embodiments, for ease of description, a computer device is used as an execution body of each operation for description. The method may include at least one of the following operations (710 to 760).

Operation 710: Obtain at least one image-text pair, each image-text pair including an original image and a complex description text corresponding to the original image.

In some embodiments, operation 710 further includes: screening the at least one image-text pair according to a length of a complex description text corresponding to the original image in each image-text pair, to obtain at least one screened image-text pair, the at least one screened image-text pair being configured for constructing a training sample.

In some embodiments, a complex description text whose length is less than a third threshold is removed, and a complex description text whose length is greater than the third threshold is reserved. A value of the third threshold is not limited in some embodiments. After an instruction text of a control parameter included in prompts is removed, because the prompts have different lengths, an excessively short prompt is not suitable as a complex prompt. Therefore, training sample data whose prompt length is less than a fixed threshold is filtered out. A prompt in reserved training data is used as a complex prompt, and each piece of training data is a bigram, for example, (complex prompt, original image).

Operation 720: Generate, for each image-text pair, a simple description text corresponding to the original image of the image-text pair.

In some embodiments, the simple description text corresponding to the original image is directly generated by using an image-to-text model.

In some embodiments, operation 720 includes at least one of operations 721 and 722.

Operation 721: Generate at least one candidate simple text for each image-text pair, and respectively calculate a matching score between each candidate simple text and the original image in the image-text pair by using a text-image matching model, the matching score being configured for representing a matching degree between each candidate simple text and the original image.

A architecture of the text-image matching model is not limited in some embodiments, and the text-image matching model is a machine learning model. In some embodiments, an input of the text-image matching model is the candidate simple text and the original image, and an output of the text-image matching model is a semantic matching degree score between the candidate simple text and the original image, for example, the matching score. In some embodiments, the input of the text-image matching model is the original image and n candidate simple texts, and the output of the text-image matching model is matching scores respectively corresponding to the n candidate simple texts, for example, n matching scores.

Operation 722: Determine the simple description text corresponding to the original image in the at least one candidate simple text according to the matching score respectively corresponding to each candidate simple text.

In some embodiments, one or more candidate simple texts having highest matching scores are selected from the matching scores respectively corresponding to the at least one candidate simple text as the simple description text corresponding to the original image.

In some embodiments, after the simple description text corresponding to the original image is determined, whether the matching score of the simple description text satisfies a predetermined condition may be further determined. If it is determined that the matching score corresponding to the simple description text does not satisfy the condition, the training sample constructed by the simple description text is removed from the training samples.

In some embodiments, when the simple description text is screened for the original image, it further needs to be considered that the matching score between the complex description text and the original image is to be less than the matching score between the simple description text and the original image. Therefore, the matching score screened as the simple description text is to be greater than the matching score between the complex description text and the original image. For example, in a case that the matching score corresponding to the simple text determined as the simple description text is not greater than the matching score between the complex description text and the original image, the training sample constructed by the simple text is removed.

In some embodiments, an open-source bootstrapping language-image pre-training (BLIP) model is invoked to generate a short description text for each picture. In some embodiments, an open-source contrastive language-image pre-training (CLIP) model is invoked to calculate a semantic matching score (a matching score) of a picture (an original image) on a simple prompt and a complex prompt. The complex prompt not only includes a text related to picture content, but also includes a text unrelated to the picture content, for example, a text describing a picture resolution and a picture style. A semantic matching degree score of the simple prompt is usually higher than a semantic matching degree score of the complex prompt. If the semantic matching score of the simple prompt is excessively low, it indicates that the matching degree between the simple prompt generated by the BLIP model and the picture is insufficient, and such training data may be filtered out. In this way, after data cleaning and filtering are performed a plurality of times, a piece of high-quality training data can be obtained. Each piece of data is a triple (including a simple prompt, a complex prompt, and an original image). Certainly, when the image generation model is trained, only the simple prompt and the complex prompt are needed.

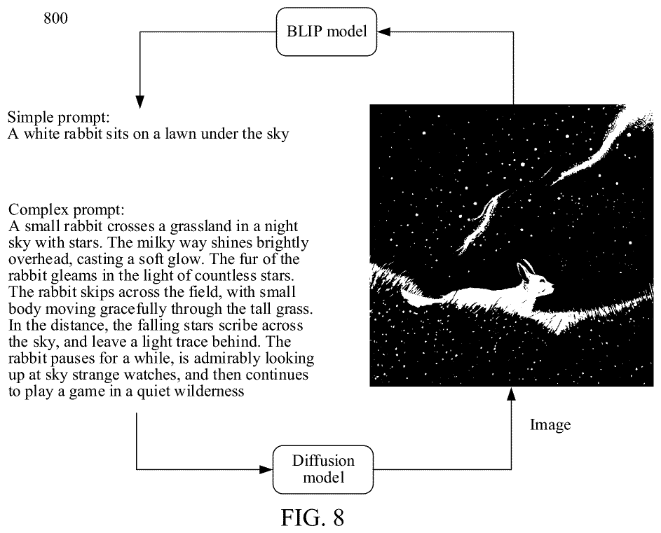

In some embodiments, as shown in 800 of FIG. 8, a plurality of simple texts are generated for the original image by using the image-to-text model-BLIP model, the matching score between each simple text and the original image is calculated by using the text-image matching model-CLIP model, and a simple text whose score is the highest and is not less than the matching score corresponding to the complex description text is selected as the simple description text of the original image.

Operation 730: Obtain at least one training sample according to the complex description text and the simple description text respectively corresponding to the at least one original image.

Operation 740: Extract, by using a text encoding module and a neural network module, a comprehensive text representation corresponding to the simple description text, the text encoding module being configured to extract a shallow representation corresponding to the simple description text, the neural network module being configured to extract a deep representation corresponding to the simple description text, the comprehensive text representation being configured for reflecting the shallow representation and the deep representation, and the comprehensive text representation being configured for generating, by using the diffusion module with reference to the original image, a predicted image corresponding to the comprehensive text representation.

Operation 750: Extract, by using the text encoding module, a reference text representation corresponding to the complex description text.

Operation 760: Adjust a parameter of an image generation model according to the comprehensive text representation and the reference text representation corresponding to the complex description text, to obtain a trained image generation model.

In some embodiments, when a training sample set is constructed, the simple description text matching the original image is determined by using the matching score, thereby improving the matching degree between the simple description text and the original image, and improving precision of the training sample. Further, the training data is filtered at least twice. One time is to filter out a complex prompt having a short length, and the other time is to filter out a simple description text having an insufficient matching score. Both of the two are intended to improve accuracy of the training sample, thereby improving a model training effect.

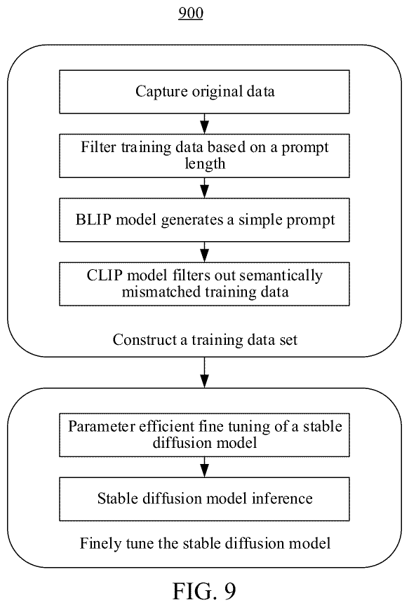

FIG. 9 is a schematic diagram of a method for training an image generation model according to some embodiments. Operations of the method may be performed by the model training device described above. In the following method embodiments, for ease of description, a computer device is used as an execution body of each operation for description.

As shown in 900 of FIG. 9, the computer device first captures original data from a website, for example, captures the original image and the complex prompt corresponding to the original image. Based on online image generation websites disclosed by midjourney and Stable Diffusion Online, these open-source image generation websites have reliable prompts carefully written by users and high-quality generated images. These prompts are complex prompts carefully written by senior users. The generated image is also semantically correct, and can be used as the original data. The computer device obtains the original data from these disclosed online image generation websites. Each piece of data includes a prompt written by a user, and a high-quality picture. In addition, the obtained original data may be cleaned. The prompt written by the user includes some instruction texts controlled by a parameter. For example, in data obtained from midjourney, a parameter “--version” or “--v” is configured for controlling a model version, and these instruction texts configured for controlling parameters need to be cleared. Next, the computer device filters training data according to a length of the prompt, generates a simple prompt according to the original image by using the BLIP model, filters out semantic mismatched training data by using the CLIP model, and constructs a training data set (a training sample set) from screened data. Then, after the training sample set is constructed, an additional neural network module and a large language model are introduced to efficiently finely tune a parameter of the stable diffusion model, and a predicted image is generated based on the simple description text by using the trained model.

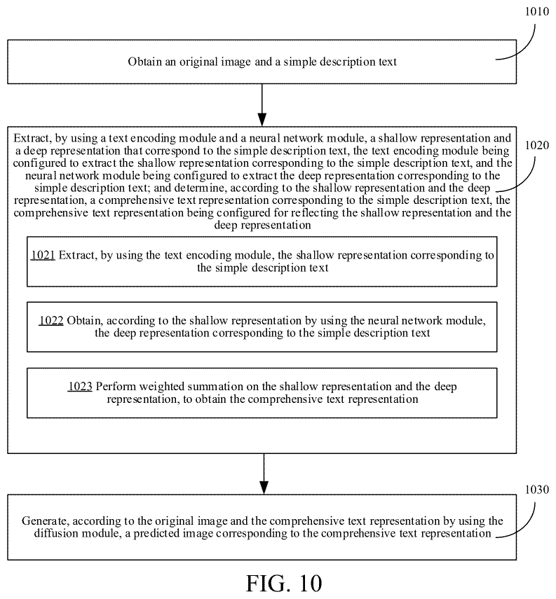

FIG. 10 is a flowchart of an image generation model-based image generation method according to some embodiments. Operations of the method may be performed by the model using device described above. In the following method embodiments, for ease of description, a computer device is used as an execution body of each operation for description. The method may include at least one of the following operations (1010 to 1030).

Operation 1010: Obtain an original image and a simple description text.

The technical solutions provided in some embodiments include at least two application scenarios. In a first case, a predicted image is generated completely according to the simple description text. In this case, the original image in a model using process may be considered as a noise image, and the noise image is generated based on a random seed. In a second case, a predicted image is generated according to the original image and the simple description text. In this case, the image generation model predicts or modifies the original image based on the original image according to the simple description text, to obtain the predicted image. In this case, the original image in the model using process may be considered as a to-be-modified image. Certainly, in the second case, if the obtained original image is the to-be-modified image, the noise image may also be superimposed based on the original image, to obtain an input image inputted to the diffusion module. For example, a size of the noise image is the same as a size of the original image, and a sum of pixel values of pixel points at corresponding positions in the original image and the noise image is determined as a pixel value of a pixel point at a corresponding position in the input image.

In some embodiments, in the model using process, it is considered that the simple description text is a text inputted by the user. For example, regardless of whether the user inputs the complex description text or the simple description text, the image generation method provided in the disclosure may be applied, and accuracy of the obtained predicted image is relatively high.

Operation 1020: Extract, by using a text encoding module and a neural network module, a comprehensive text representation corresponding to the simple description text, the text encoding module being configured to extract a shallow representation corresponding to the simple description text, the neural network module being configured to extract a deep representation corresponding to the simple description text, and the comprehensive text representation being configured for reflecting the shallow representation and the deep representation.

In some embodiments, operation 1020 includes at least one of operations 1021 to 1023.

Operation 1021: Extract, by using the text encoding module, the shallow representation corresponding to the simple description text.

Operation 1022: Obtain, according to the shallow representation by using the neural network module, the deep representation corresponding to the simple description text.

Operation 1023: Perform weighted summation on the shallow representation and the deep representation, to obtain the comprehensive text representation.

For operations 1020 to 1023 in some embodiments, refer to explanations and descriptions in the foregoing embodiment on the model training side.

Operation 1030: Generate, according to the original image and the comprehensive text representation by using the diffusion module, a predicted image corresponding to the comprehensive text representation.

In some embodiments, a forward process of the diffusion module is also referred to as a diffusion process, and is configured for adding noise to the input data in sequence until the input data approaches pure noise. For example, the whole diffusion process may be a parameterized Markov chain. In some embodiments, an original image with noise is encoded by using a first encoder, to obtain an initial feature vector of the original image with noise; and noise addition is performed on the initial feature vector for T times by using the forward process of the diffusion module, to generate a latent space representation corresponding to the original image with noise, T being a positive integer. In some embodiments, the forward process of the diffusion module is to denoise the initial feature vector for T times, to generate the latent space representation corresponding to a random noise image. A backward process of the diffusion module is to denoise the latent space representation for T times according to the text representation, to obtain a denoised latent space representation. The backward process of the diffusion module is configured for removing noise in sequence from the input data according to a constraint condition, to generate the predicted image. For example, the whole backward process of the diffusion module may also be a parameterized Markov chain. In some embodiments, the latent space representation and the text representation are used as the input data of the backward process of the diffusion module, and the backward process of the diffusion module performs denoising constraint in sequence on a latent space feature based on the text representation, so that the predicted image satisfies a constraint requirement of the text representation. In some embodiments, the text representation inputted to the diffusion module may be considered as the comprehensive text representation corresponding to the simple description text.

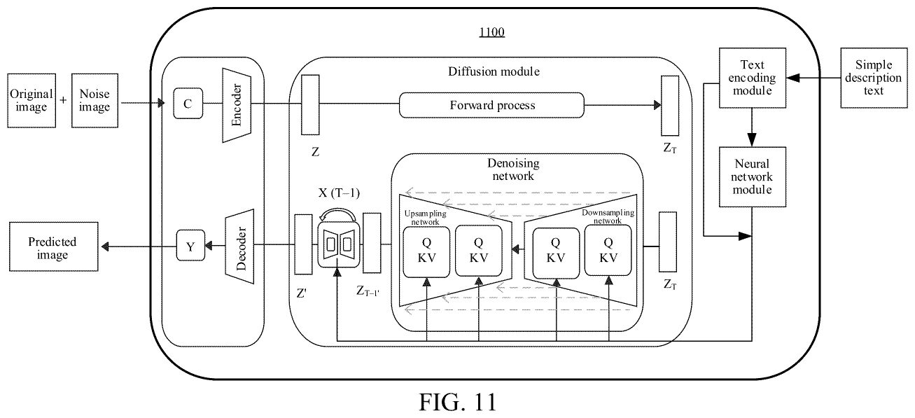

In some embodiments, as shown in FIG. 11, FIG. 11 is a schematic structural diagram of an image generation model 1100. An input image (a noise image or an original image on which the noise image is superimposed) is encoded by using an encoder, to obtain an initial feature vector Z of the input image. A text encoding module generates, according to a simple description text, a shallow representation corresponding to the simple description text, and a neural network module generates, according to the shallow representation, a deep representation corresponding to the simple description text, and performs weighted summation on the shallow representation and the deep representation, to obtain a comprehensive text representation. The comprehensive text representation is used as input data of a denoising network. Noise addition is performed on the initial feature vector for T times by using a forward process of a diffusion module, to generate a latent space representation Z_{T} corresponding to the input image. The latent space representation Z_{T} and the text representation are used as input data of a downsampling network of the denoising network, input data of an upsampling network is obtained according to output data of the downsampling network, and the upsampling network obtains, according to the text representation and the input data of the upsampling network, an output feature Z_{T-1′} obtained after denoising for one time. A denoised latent space representation Z′ is obtained after T−1 times of the denoising network. The denoised latent space representation Z′ is decoded by using a decoder, to generate a predicted image Y.

An apparatus embodiment of the disclosure is described below, which may be configured for performing the method embodiments of the disclosure. Details not disclosed in the apparatus embodiment of the disclosure may be similar to those in the method embodiments of the disclosure.

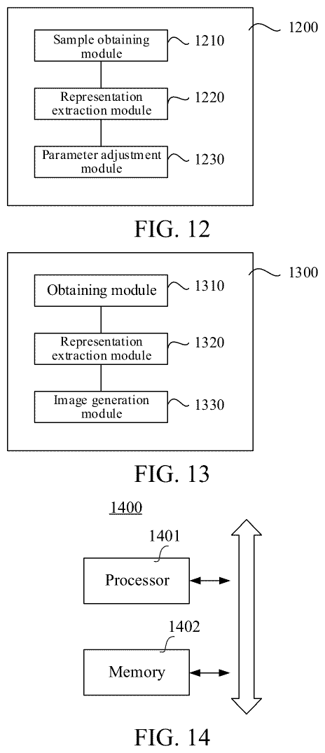

FIG. 12 is a block diagram of an apparatus for training an image generation model according to some embodiments. The image generation model includes a neural network module, a pre-trained text encoding module, and a pre-trained diffusion module. As shown in FIG. 12, an apparatus 1200 may include: a sample obtaining module 1210, a representation extraction module 1220, and a parameter adjustment module 1230.

The sample obtaining module 1210 is configured to obtain at least one training sample, each training sample including a complex description text and a simple description text that correspond to an original image.

The representation extraction module 1220 is configured to extract, by using the text encoding module and the neural network module, a shallow representation and a deep representation that correspond to the simple description text, the text encoding module being configured to extract the shallow representation corresponding to the simple description text, and the neural network module being configured to extract the deep representation corresponding to the simple description text; and determine, according to the shallow representation and the deep representation, a comprehensive text representation corresponding to the simple description text, the comprehensive text representation being configured for generating, by using the diffusion module with reference to the original image, a predicted image corresponding to the comprehensive text representation.

The representation extraction module 1220 is further configured to input the complex description text to the text encoding module, to extract a reference text representation corresponding to the complex description text.

The parameter adjustment module 1230 is configured to adjust a parameter of the image generation model according to the comprehensive text representation and the reference text representation corresponding to the complex description text, to obtain a trained image generation model.

FIG. 13 is a block diagram of an image generation model-based image generation apparatus according to some embodiments. The image generation model includes a neural network module, a text encoding module, and a diffusion module. As shown in FIG. 13, an apparatus 1300 may include: an obtaining module 1310, a representation extraction module 1320, and an image generation module 1330.

The obtaining module 1310 is configured to obtain an original image and a simple description text.

The representation extraction module 1320 is configured to extract, by using the text encoding module and the neural network module, a shallow representation and a deep representation that correspond to the simple description text, the text encoding module being configured to extract the shallow representation corresponding to the simple description text, and the neural network module being configured to extract the deep representation corresponding to the simple description text; and determine, according to the shallow representation and the deep representation, a comprehensive text representation corresponding to the simple description text, the comprehensive text representation being configured for reflecting the shallow representation and the deep representation.

The image generation module 1330 is configured to generate, according to the original image and the comprehensive text representation by using the diffusion module, a predicted image corresponding to the comprehensive text representation.

When the apparatus provided in the foregoing embodiment implements the functions thereof, merely division of the foregoing function modules is used as an example for description. In actual application, the functions may be allocated to and completed by different function modules based on needs. For example, an internal structure of a device is divided into the different function modules, to complete all or some of the functions described above. In addition, the apparatus and method embodiments provided in the foregoing embodiments belong to the same conception. For a implementation process, reference may be made to the method embodiments.

FIG. 14 is a structural block diagram of a computer device 1400 according to some embodiments. The computer device 1400 may be any electronic device having data calculation, processing, and storage capabilities. The computer device 1400 may be configured to implement the foregoing method for training an image generation model, or implement the foregoing image generation model-based image generation method.

Generally, the computer device 1400 includes a processor 1401 and a memory 1402.

The processor 1401 may include one or more processing cores, for example, a 4-core processor and an 8-core processor. The processor 1401 may be implemented in at least one hardware form of a digital signal processor (DSP), a field programmable gate array (FPGA), and a programmable logic array (PLA). The processor 1401 may alternatively include a main processor and a coprocessor, and the main processor is a processor for processing data in a wake-up state, also referred to as a central processing unit (CPU). The coprocessor is a low power consumption processor configured for processing data in a standby state. In some embodiments, the processor 1401 may be integrated with a graphics processing unit (GPU). The GPU is configured to render and draw content that may be displayed on a display screen. In some embodiments, the processor 1401 may further include an AI processor. The AI processor is configured to process a calculation operation related to machine learning.

The memory 1402 may include one or more computer-readable storage media. The computer-readable storage medium may be non-transient. The memory 1402 may further include a high-speed random access memory and a nonvolatile memory, for example, one or more disk storage devices or flash storage devices. In some embodiments, the non-transitory computer-readable storage medium in the memory 1402 is configured to store a computer program, and the computer program is configured to be executed by one or more processors, to implement the foregoing method for training an image generation model, or implement the foregoing image generation model-based image generation method.

A person skilled in the art may understand that the structure shown in FIG. 14 does not constitute a limitation on the computer device 1400, and the computer device 1400 may include more or fewer components than those shown in the figure, or some components may be combined, or a different component deployment may be used.

In an exemplary embodiment, a computer-readable storage medium is further provided. The storage medium has a computer program stored therein, and the computer program, when executed by a processor, implements the foregoing method for training an image generation model or the foregoing image generation model-based image generation method. In some embodiments, the computer-readable storage medium may include a read-only memory (ROM), a random access memory (RAM), a solid state drive (SSD), an optical disc, or the like. The RAM may include a resistance random access memory (ReRAM) and a dynamic random access memory (DRAM).

In some embodiments, a computer program product is further provided. The computer program product includes a computer program, and the computer program is stored in a computer-readable storage medium. A processor of a computer device reads the computer program from the computer-readable storage medium, and the processor executes the computer program, so that the computer device performs the foregoing method for training an image generation model or implements the foregoing image generation model-based image generation method.

In the disclosure, during example application of the relevant data (including an original image, a simple description text, or a complex description text) collection and processing, the informed consent or individual consent of a personal information subject may be obtained in strict accordance with the requirements of relevant national laws and regulations, and the subsequent data use and processing behavior is carried out within the scope of authorization of laws and regulations and the personal information subject.

“A plurality of” described in this specification refers to two or more. “And/or” describes an association relationship between associated objects and indicates that three relationships may exist. For example, A and/or B may indicate the following three cases: A alone, both A and B, and B alone. The character “/” generally indicates that associated objects in the context are in an “or” relationship. In addition, the operation numbers described in this specification merely exemplarily show a possible execution sequence between the operations. In some other embodiments, the operations may not be performed based on a number sequence. For example, two operations having different numbers are performed simultaneously, or the two operations having different numbers are performed based on a sequence contrary to that shown in the figure. This is not limited in some embodiments.

The above descriptions are merely some embodiments, but are not intended to limit the disclosure. Any modification, equivalent replacement, improvement or the like made within the spirit and principle of the disclosure is to fall within the protection scope of the disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for training an image generation model, performed by a computer device, and the method comprising:
obtaining at least one training sample, each training sample comprising a first description text and a second description text that corresponds to an original image, wherein the second description text comprises a greater number of keywords describing the original image than the first description text;
extracting a shallow representation that corresponds to the first description text with a text encoder and a deep representation that corresponds to the first description text with a neural network;
determining, based on the shallow representation and the deep representation, a comprehensive text representation corresponding to the first description text;
generating, based on a diffusion model of the original image, a predicted image corresponding to the comprehensive text representation;
inputting the second description text to the text encoder, to extract a reference text representation corresponding to the second description text; and
adjusting at least one parameter of the image generation model based on the comprehensive text representation and the reference text representation corresponding to the second description text, to obtain a trained image generation model.

2. The method according to claim 1, wherein the extracting comprises:
inputting the first description text to the text encoder, to extract the shallow representation corresponding to the first description text; and
inputting the shallow representation to the neural network, to obtain the deep representation corresponding to the first description text; and
wherein the determining comprises:
performing dimension alignment and weighted summation on the shallow representation and the deep representation, to obtain the comprehensive text representation.

3. The method according to claim 1,
wherein the adjusting comprises:
determining a first loss function value based on a difference between the comprehensive text representation and the reference text representation corresponding to the second description text; and
adjusting the at least one parameter of the image generation model based on the first loss function value, to obtain the trained image generation model.

4. The method according to claim 1, further comprising:
inputting the first description text to a language model, to extract a reference text representation corresponding to the first description text; and
determining a second loss function value based on a difference between the deep representation corresponding to the first description text and the reference text representation corresponding to the first description text; and
wherein the adjusting comprises:
determining a first loss function value based on a difference between the comprehensive text representation and the reference text representation; and
adjusting the at least one parameter of the image generation model based on the first loss function value and the second loss function value, to obtain the trained image generation model.

5. The method according to claim 4, wherein the adjusting further comprises:
performing weighted summation on the first loss function value and the second loss function value, to obtain a comprehensive loss function value; and
adjusting the at least one parameter of the image generation model based on the comprehensive loss function value, to obtain the trained image generation model.

6. The method according to claim 1, wherein the adjusting comprises:
adjusting at least one parameter of the neural network, in a case that parameters of the text encoder and the diffusion model in the image generation model remain unchanged.

7. The method according to claim 1, wherein the obtaining at least one training sample comprises:
obtaining at least one image-text pair comprising an original image and a second description text corresponding to the original image;
generating, for each of the at least one image-text pair, a first description text corresponding to the original image of the image-text pair; and
obtaining the at least one training sample based on the at least one image-text pair and the first description text generated for the at least one image-text pair.

8. The method according to claim 7, wherein the generating comprises:
generating at least one candidate first text for each of the at least one image-text pair;
calculating a matching score for representing a matching degree between each of the at least one candidate first text and the original image based on a text-image matching model; and
determining the first description text corresponding to the original image in the at least one candidate first text based on the matching score.

9. The method according to claim 8, further comprising:
based on the matching score not satisfying a preset condition, filtering out the at least one image-text pair and the first description text corresponding to the at least one image-text pair from the training sample.

10. The method according to claim 7, wherein the obtaining at least one image-text pair comprises:
obtaining candidate image-text pairs, and
screening the candidate image-text pairs based on a length of the second description text corresponding to the original image in each of the candidate image-text pairs, to obtain the at least one image-text pair.

11. An apparatus for training an image generation model, comprising:
at least one memory configured to store program code; and
at least one processor configured to read the program code and operate as instructed by the program code, the program code comprising:
obtaining code configured to cause at least one of the at least one processor to obtain at least one training sample, each training sample comprising a first description text and a second description text that corresponds to an original image, wherein the second description text comprises a greater number of keywords describing the original image than the first description text;
extracting code configured to cause at least one of the at least one processor to extract a shallow representation that corresponds to the first description text with a text encoder and a deep representation that corresponds to the first description text with a neural network;
determining code configured to cause at least one of the at least one processor to determine, based on the shallow representation and the deep representation, a comprehensive text representation corresponding to the first description text;
generating code configured to cause at least one of the at least one processor to generate, based on a diffusion model of the original image, a predicted image corresponding to the comprehensive text representation;
inputting code configured to cause at least one of the at least one processor to input the second description text to the text encoder, to extract a reference text representation corresponding to the second description text; and
adjusting code configured to cause at least one of the at least one processor to adjust at least one parameter of the image generation model based on the comprehensive text representation and the reference text representation corresponding to the second description text, to obtain a trained image generation model.

12. The apparatus according to claim 11, wherein the extracting code is further configured to cause at least one of the at least one processor to:
input the first description text to the text encoder, to extract the shallow representation corresponding to the first description text; and
input the shallow representation to the neural network, to obtain the deep representation corresponding to the first description text; and
wherein the determining code is further configured to cause at least one of the at least one processor to:
perform dimension alignment and weighted summation on the shallow representation and the deep representation, to obtain the comprehensive text representation.

13. The apparatus according to claim 11,
wherein the adjusting code is further configured to cause at least one of the at least one processor to:
determine a first loss function value based on a difference between the comprehensive text representation and the reference text representation corresponding to the second description text; and
adjust the at least one parameter of the image generation model based on the first loss function value, to obtain the trained image generation model.

14. The apparatus according to claim 11, wherein the program code further comprises:
language code configured to cause at least one of the at least one processor to input the first description text to a language model, to extract a reference text representation corresponding to the first description text; and
loss code configured to cause at least one of the at least one processor to determine a second loss function value based on a difference between the deep representation corresponding to the first description text and the reference text representation corresponding to the first description text; and
wherein the adjusting code is further configured to cause at least one of the at least one processor to:
determine a first loss function value based on a difference between the comprehensive text representation and the reference text representation; and
adjust the at least one parameter of the image generation model based on the first loss function value and the second loss function value, to obtain the trained image generation model.

15. The apparatus according to claim 14, wherein the adjusting code is further configured to cause at least one of the at least one processor to:
perform weighted summation on the first loss function value and the second loss function value, to obtain a comprehensive loss function value; and
adjust the at least one parameter of the image generation model based on the comprehensive loss function value, to obtain the trained image generation model.

16. The apparatus according to claim 11, wherein the adjusting code is further configured to cause at least one of the at least one processor to:
adjust at least one parameter of the neural network, in a case that parameters of the text encoder and the diffusion model in the image generation model remain unchanged.

17. The apparatus according to claim 11, wherein the obtaining code is further configured to cause at least one of the at least one processor to:
obtain at least one image-text pair comprising an original image and a second description text corresponding to the original image;
generate, for each of the at least one image-text pair, a first description text corresponding to the original image of the image-text pair; and
obtain the at least one training sample based on the at least one image-text pair and the first description text generated for the at least one image-text pair.

18. The apparatus according to claim 17, wherein the obtaining code is further configured to cause at least one of the at least one processor to:
generate at least one candidate first text for each of the at least one image-text pair;
calculate a matching score for representing a matching degree between each of the at least one candidate first text and the original image based on a text-image matching model; and
determine the first description text corresponding to the original image in the at least one candidate first text based on the matching score.

19. The apparatus according to claim 18, wherein the program code further comprises:
filtering code configured to cause at least one of the at least one processor to filter out, based on the matching score not satisfying a preset condition, the at least one image-text pair and the first description text corresponding to the at least one image-text pair from the training sample.

20. A non-transitory computer-readable storage medium, storing computer code which, when executed by at least one processor, causes the at least one processor to at least:
obtain at least one training sample, each training sample comprising a first description text and a second description text that corresponds to an original image, wherein the second description text comprises a greater number of keywords describing the original image than the first description text;
extract a shallow representation that corresponds to the first description text with a text encoder and a deep representation that corresponds to the first description text with a neural network;
determine, based on the shallow representation and the deep representation, a comprehensive text representation corresponding to the first description text;
generate, based on a diffusion model of the original image, a predicted image corresponding to the comprehensive text representation;
input the second description text to the text encoder, to extract a reference text representation corresponding to the second description text; and
adjust at least one parameter of the image generation model based on the comprehensive text representation and the reference text representation corresponding to the second description text, to obtain a trained image generation model.
